(19) United States
(12) Patent Application Publication
(10) Pub. No.: US 2026/0331980 A1
(43) Pub. Date: Oct. 22, 2026

(54) ROTARY ELECTRIC MACHINE

(71) Applicant: MITSUBISHI ELECTRIC MOBILITY CORPORATION, Tokyo (JP)

(72) Inventors: Tetsuya MINEYUKI, Tokyo (JP); Keiichi KONISHI, Tokyo (JP); Masahiro KANEMARU, Tokyo (JP)

(73) Assignee: MITSUBISHI ELECTRIC MOBILITY CORPORATION, Tokyo (JP)

(21) Appl. No.: 19/110,469

(22) PCT Filed: Oct. 17, 2022
(86) PCT No.: PCT/JP2022/038589

§ 371 Date: Mar. 11, 2025

(51) Int. Cl. H02K 1/30; H02K 1/276; H02K 21/16

(52) U.S. Cl. CPC H02K 1/30; H02K 1/276; H02K 21/16

(57) ABSTRACT

A rotary electric machine includes: a stator; and a rotor composed of a rotor core formed of electromagnetic steel sheets arranged to be stacked, and a plurality of permanent magnets arranged in the rotor core at regular intervals in a circumferential direction. In the rotary electric machine, axial-direction holding bodies, a rotation holding body, and suppression constituents are provided. The axial-direction holding bodies are arranged on an inner side in a radial direction relative to the permanent magnets, the number of the axial-direction holding bodies being half the number of magnetic poles of the rotor. The rotation holding body is formed in a cylindrical shape and has an outer cylinder portion on which the rotor core is disposed. Each of the suppression constituents suppresses a bending moment for which the corresponding axial-direction holding body serves as a fulcrum.

### TECHNICAL FIELD

The present disclosure relates to a rotary electric machine.

### BACKGROUND ART

A conventional rotary electric machine has, for example, a rotor structure in which a rotor core generally used in a rotary electric machine for an electrically-driven vehicle is held by a cylindrical rotation holding body coupled to a shaft. In this rotor structure, the proportion of the diameter of the rotation holding body to the outer diameter of the rotor core is high. As a result, a structure in which the thickness in a radial direction of the rotor core is small is sometimes employed (see, for example, Patent Document 1).

In addition, another rotor structure has been described. This rotor structure has a shape obtained by welding an inner-diameter portion through fixation of stacked layers of a rotor core and is provided with stress relaxation holes for suppressing deformation due to thermal strain at the time of the welding, in order to ensure centrifugal force resistance in the rotor structure (see, for example, Patent Document 2).

### CITATION LIST

### Patent Document

Patent Document 1: Japanese Laid-Open Patent Publication No. 2012-100477
Patent Document 2: WO2014/208582A1

### SUMMARY OF THE INVENTION

### Problem to be Solved by the Invention

Regarding the above conventional rotary electric machine, the structure in Patent Document 1 has the following problem. That is, the rotor structure in which the thickness in the radial direction of the rotor core is small is employed as described above, and thus, when the rotor core is press-fitted onto the rotation holding body, a bending moment for which a swaged portion serves as a fulcrum is applied, and concentration of stress on a thin portion at a position corresponding to the core outer diameter of the rotor core occurs, whereby the strength of the rotor core is decreased.

In addition, Patent Document 2 has the following problem. That is, although a sufficient tolerance for the thickness in the radial direction is present for fixation of the stacked layers by welding, and the stress relaxation holes for suppressing deformation due to thermal strain at the time of the welding are provided, an effect of decreasing stress when the thickness in the radial direction is small becomes low, whereby the stress relaxation holes need to be made large.

The present disclosure has been made to solve the above problems, and an object of the present disclosure is to provide a rotary electric machine capable of suppressing concentration of stress on a thin portion of a rotor core.

### Means to Solve the Problem

A rotary electric machine according to the present disclosure is a rotary electric machine including: a stator; and a rotor composed of a rotor core disposed with a magnetic gap between the rotor core and the stator and formed of electromagnetic steel sheets arranged to be stacked, and a plurality of permanent magnets arranged in the rotor core at regular intervals in a circumferential direction. In the rotary electric machine, axial-direction holding bodies, a rotation holding body, and suppression constituents are provided. The axial-direction holding bodies are arranged on an inner side in a radial direction relative to the permanent magnets, the number of the axial-direction holding bodies being half the number of magnetic poles of the rotor. The rotation holding body is formed in a cylindrical shape and has an outer cylinder portion on which the rotor core is disposed. Each of the suppression constituents suppresses a bending moment for which the corresponding axial-direction holding body serves as a fulcrum.

### Effect of the Invention

The rotary electric machine according to the present disclosure is configured such that: the axial-direction holding bodies are arranged on the inner side in the radial direction relative to the permanent magnets, the number of the axial-direction holding bodies being half the number of the magnetic poles of the rotor; the rotor core is disposed on the outer cylinder portion of the rotation holding body formed in a cylindrical shape; and each of the suppression constituents suppresses a bending moment for which the corresponding axial-direction holding body serves as a fulcrum. Consequently, a rotary electric machine capable of suppressing concentration of stress on a thin portion of a rotor core can be obtained.

### BRIEF DESCRIPTION OF THE DRAWINGS

FIG. 1 is a cross-sectional view showing a rotary electric machine according to embodiment 1.

FIG. 2 is a perspective view showing a rotor core in the rotary electric machine according to embodiment 1.

FIG. 3 is a perspective view showing a rotation holding body in the rotary electric machine according to embodiment 1.

FIG. 4 is a cross-sectional view showing a rotor in the rotary electric machine according to embodiment 1, the cross-sectional view extending in a rotation-axis circumferential direction of the rotor.

FIG. 5 is an enlarged cross-sectional view of a main part, in FIG. 4, of the rotary electric machine according to embodiment 1.

FIG. 6 is a cross-sectional view showing a rotor in a rotary electric machine according to embodiment 2, the cross-sectional view extending in the rotation-axis circumferential direction of the rotor.

FIG. 7 is a cross-sectional view showing the rotor in the rotary electric machine according to embodiment 2, the cross-sectional view extending in the rotation-axis circumferential direction of the rotor.

FIG. 8 is a cross-sectional view showing a modification that is a rotation holding body in a rotary electric machine according to embodiment 3.

FIG. 9 is a cross-sectional view showing a modification that is a rotation holding body in the rotary electric machine according to embodiment 3.

FIG. 10 is a cross-sectional view of a main part of a modification that is a rotor in a rotary electric machine according to embodiment 4, the cross-sectional view extending in the rotation-axis circumferential direction of the rotor.

FIG. 11 is a cross-sectional view showing a rotor in a rotary electric machine according to embodiment 5, the cross-sectional view extending in the rotation-axis circumferential direction of the rotor.

FIG. 12 is an enlarged cross-sectional view of a main part, in FIG. 11, of the rotary electric machine according to embodiment 5.

FIG. 13 is a cross-sectional view showing a rotor in a rotary electric machine according to embodiment 6, the cross-sectional view extending in the rotation-axis circumferential direction of the rotor.

FIG. 14 is an enlarged cross-sectional view of a main part, in FIG. 13, of the rotary electric machine according to embodiment 6.

### DESCRIPTION OF EMBODIMENTS

### Embodiment 1

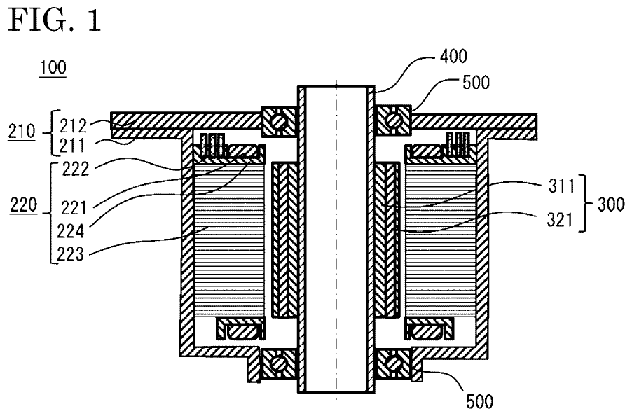

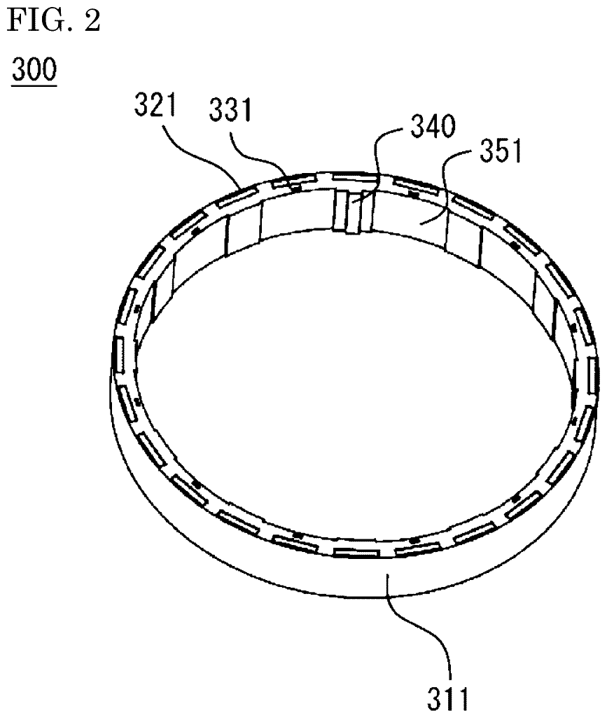

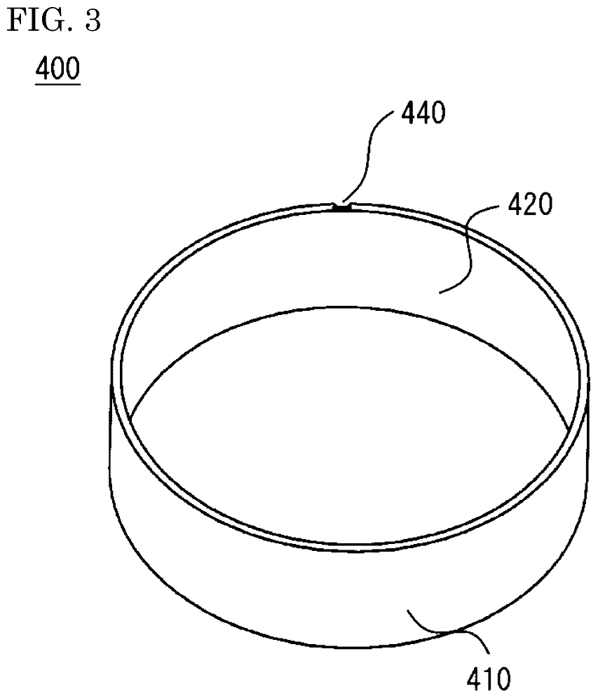

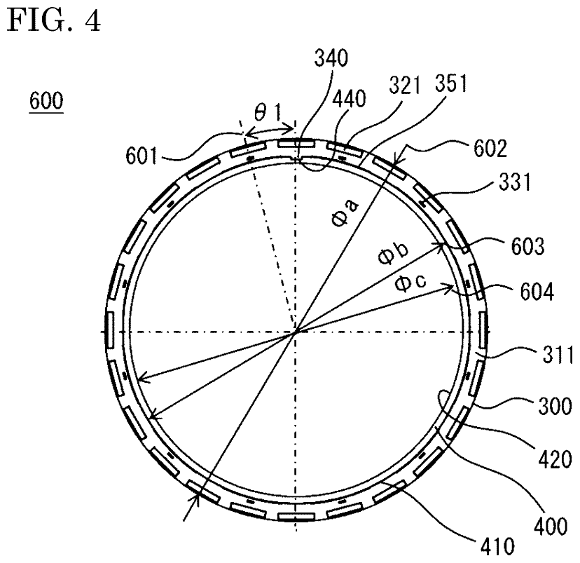

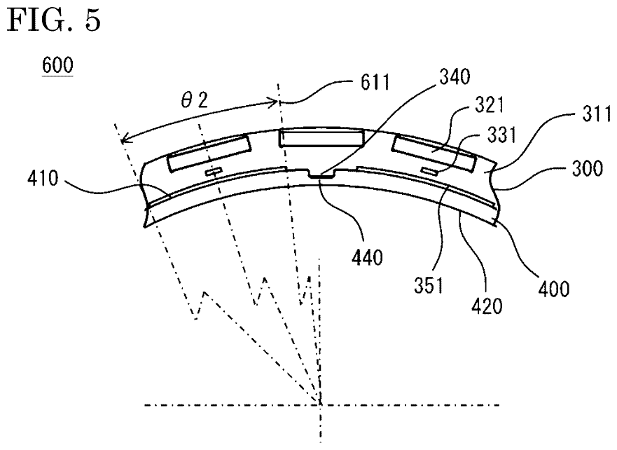

Hereinafter, embodiment 1 of the present disclosure will be described with reference to FIG. 1 to FIG. 5, and the same or corresponding members and portions in the drawings will be described while being denoted by the same reference characters. FIG. 1 is a cross-sectional view showing a rotary electric machine according to embodiment 1. FIG. 2 is a perspective view showing a rotor core in the rotary electric machine according to embodiment 1. FIG. 3 is a perspective view showing a rotation holding body in the rotary electric machine according to embodiment 1. FIG. 4 is a cross-sectional view showing a rotor in the rotary electric machine according to embodiment 1, the cross-sectional view extending in a rotation-axis circumferential direction of the rotor. FIG. 5 is an enlarged cross-sectional view of a main part, in FIG. 4, of the rotary electric machine according to embodiment 1.

As shown in FIG. 1, a rotary electric machine 100 includes: a housing 210 composed of a cylindrical frame 211 having a bottom and an end plate 212 closing an opening of the frame 211; and an armature 220 which is a stator fixed to a cylindrical portion of the frame 211 in an internally fitted state.

The armature 220 is composed of: a plurality of coils 221 which generate magnetic fluxes; wire connection plates 222 which distribute current to the plurality of coils 221; and an armature core 223 for causing the magnetic fluxes to flow. The coils 221, the wire connection plates 222, and the armature core 223 are each fixed to a bobbin 224 and electrically insulated.

The provided wire connection plates 222, the number of which is three, correspond to three phases and are connected to the coils 221 for the respective different phases.

A rotor 300 is composed of: a rotor core 311 disposed with a magnetic gap between the rotor core 311 and the armature 220 and formed of electromagnetic steel sheets arranged to be stacked; and a plurality of permanent magnets 321 arranged in the rotor core 311 at regular intervals in the circumferential direction.

The rotor core 311 is disposed on an outer cylinder portion of a rotation holding body 400 formed in a cylindrical shape, and the rotation holding body 400 is structurally connected to the rotor 300 and extends in a rotation axis direction. The rotation holding body 400 is rotatably borne by bearings 500 provided to the housing 210.

The above configuration leads to employment of a structure in which: the proportion of the diameter of the rotation holding body 400 to the outer diameter of the rotor core 311 is high; and the thickness in a rotation-axis radial direction of the rotor core 311 is comparatively small. The employed structure is advantageous in: decreasing cost by decreasing the usage amount of the electromagnetic steel sheets forming the rotor core 311; or, regarding a rotation holding body material for holding the rotor core 311, decreasing the weight of a rotation axis member by, for example, providing a space between the rotation axis and the cylindrical rotation holding body 400.

This configuration example shown in FIG. 1 is related to the case of a configuration in which the rotation holding body 400 for holding the rotor core 311 is rotatably borne by the bearings 500 directly. Without limitation thereto, it is also possible to employ, for example, a configuration in which: a shaft (not shown) having a smaller diameter than the rotation holding body 400 is separately provided at the position of the rotation axis with a cavity between the shaft and an inner-diameter portion of the rotation holding body 400; and the shaft is rotatably supported by the bearings 500. Furthermore, it is also possible to employ a configuration in which the rotation holding body 400 and the shaft are coupled to be integrated with each other via a coupling member (not shown) extending in the radial direction so that a rotation holding body member for holding the rotor core 311 is obtained.

In this manner, a configuration in which such a shaft is disposed with a cavity between the shaft and the inner-diameter portion of the rotation holding body 400 is employed, and in this case as well, a space is provided between the rotation holding body and each of the rotation axis and the shaft, whereby a structure that is advantageous in decreasing the weight can be obtained in the same manner as in the configuration shown in FIG. 1.

In addition, the permanent magnets 321 are embedded on the outer circumferential surface side of the rotor core 311 and are arranged at a predetermined pitch and at regular intervals in the circumferential direction, to form magnetic poles. Also, a silicon-resin-based adhesive is used between each of the permanent magnets 321 and the rotor core 311 and is heated and cured so as to achieve structural fixation therebetween.

As shown in FIG. 2, the polarities of the plurality of permanent magnets 321 arranged in the rotor core 311 at regular intervals in the rotation-axis circumferential direction are alternately present, and axial-direction holding bodies 331 are arranged at regular intervals on an inner side in the radial direction relative to the permanent magnets 321, the number of the axial-direction holding bodies 331 being half the number of the magnetic poles of the rotor 300. A core fitting portion 340 for positioning the rotor core 311 in the circumferential direction is provided on an inner circumferential portion of the rotor core 311.

As suppression constituents, for example, recesses 351 are provided, in the inner circumferential portion of the rotor core 311, on the inner side in the radial direction relative to the axial-direction holding bodies 331. The number of the provided recesses 351 is equal to the number of the axial-direction holding bodies 331, i.e., is half the number of the magnetic poles. Each of the recesses 351 suppresses a bending moment for which the corresponding axial-direction holding body 331 serves as a fulcrum. Each of the recesses 351 as suppression constituents is characterized in that the width thereof in the circumferential direction is equal to or larger than an angle corresponding to the number of poles of the permanent magnets 321.

Each of the axial-direction holding bodies 331 has a V-swaged structure for holding the electromagnetic steel sheets in the rotation axis direction, in which punching has been performed, such that a cross-sectional shape in the rotation-axis circumferential direction becomes a V shape at the time of performing press work on the electromagnetic steel sheets. Meanwhile, the axial-direction holding body 331 easily sustains eddy-current loss owing to residual stress remaining after the punching and decrease in insulation properties between the stacked layers. Considering this, the axial-direction holding body 331 is characterized by being disposed on the inner side in the rotation-axis radial direction relative to the corresponding permanent magnet 321 in order to decrease influence of magnetic properties.

As shown in FIG. 3, the rotation holding body 400 has an outer cylinder portion 410 at which the rotor core 311 is press-fitted onto the rotation holding body 400, and a rotation holding inner cylinder portion 420 for providing a cavity within the inner-diameter portion of the rotation holding body 400, and the rotation holding body 400 is characterized by having a structure in which the rotation holding inner cylinder portion 420 can be mounted with the shaft or a part for suppressing vibration upon transmission of axial force.

In addition, the rotation holding body 400 has a rotation holding fitting portion 440 for positioning the core fitting portion 340 of the rotor core 311 and is characterized by having a structure that facilitates assembly by providing a minute gap between the core fitting portion 340 of the rotor core 311 and the rotation holding fitting portion 440. In a case where accuracy is required for the positioning, the positioning may be adjusted by providing a plurality of the core fitting portions 340 of the rotor core 311 and a plurality of the rotation holding fitting portions 440 instead of one said core fitting portion 340 and one said rotation holding fitting portion 440.

FIG. 4 and FIG. 5 show a rotor structure 600 obtained by disposing the rotor 300 onto the rotation holding body 400. This structure is characterized in that: the rotor core 311 and the rotation holding body 400 are arranged to be positioned in the rotation-axis circumferential direction by means of the core fitting portion 340 and the rotation holding fitting portion 440; and the rotor 300 is press-fitted onto, and fitted to, the rotation holding body 400. As the fitting, shrink-fitting or cold fitting may be performed.

This structure is characterized in that, in a case where an angle 601 between the positions in the rotation-axis circumferential direction of the core fitting portion 340 and each of the axial-direction holding bodies 331 of the rotor core 311 is defined as 01 and a width angle 611 in the rotation-axis circumferential direction of the corresponding recess 351 as a suppression constituent is defined as 02, the following relationship is established.

[Mathematical 1]

θ1≤δ2 (expression 1)

In addition, this structure is characterized in that: in a case where an outermost-diameter portion 602 of the rotor core 311 is defined as φa and an innermost-diameter portion 603 of the rotor core 311 is defined as φb, a relationship is established; and the thickness in the rotation-axis radial direction of the rotor core 311 is equal to or smaller than 10% of the outermost-diameter portion 602.

The established relationship is as follows.

$$[ Mathematical 2 ]$$

$$\frac{∅ a - ∅ b}{2} \leq 0.1 \cdot ∅ a \qquad ( expression 2 )$$

In addition, this structure is characterized in that: in a case where a diameter 604 of the rotation holding inner cylinder portion 420 of the rotation holding body 400 is defined as φc, a relationship is established; and the thickness in the rotation-axis radial direction of the rotation holding body 400 is equal to or smaller than 10% of the outermost-diameter portion 602 of the rotor core 311. The established relationship is as follows.

$$[ Mathematical 3 ]$$

$$\frac{∅ b - ∅ c}{2} \leq 0.1 \cdot ∅ a \qquad ( expression 3 )$$

As in this basic configuration of embodiment 1, the rotor 300 has a configuration in which the rotor core 311 which is fixed to the outer cylinder portion of the cylindrical rotation holding body 400 connected with respect to the rotation axis is provided with: the axial-direction holding bodies 331 arranged at regular intervals on the inner side in the radial direction relative to the permanent magnets 321, the number of the axial-direction holding bodies 331 being half the number of the magnetic poles of the rotor 300; and the recesses 351 as suppression constituents arranged on the inner side in the rotation-axis radial direction relative to the axial-direction holding bodies 331. This configuration leads to obtainment of a configuration in which each of the provided recesses 351 as suppression constituents suppresses application of a bending moment, for which the corresponding axial-direction holding body 331 serves as a fulcrum, when the rotor core 311 is press-fitted onto the rotation holding body 400, the bending moment being attributed to the employment of the rotor configuration in which the thickness in the radial direction of the rotor core 311 is small.

As a result, it is possible to suppress generation of local stresses at the outermost-diameter portion 602 of the rotor core 311 and a position at which the thickness in the rotation-axis radial direction of the corresponding permanent magnet 321 is small. This advantageous effect of the present disclosure becomes more prominent as described below in a case where the proportion of the thickness in the rotation-axis radial direction of the rotor core 311 or the rotation holding body 400 to the outer diameter of the outermost-diameter portion 602 is equal to or lower than 10% as described above.

In a case where a significant axial deviation occurs when the rotor core 311 and the rotation holding body 400 are fitted to each other, correction of the innermost-diameter portion 603 of the rotor core 311 in the rotation axis direction with respect to the rotation holding body 400 causes a bending moment, for which each of the axial-direction holding bodies 331 serves as a fulcrum, to be transmitted via the axial-direction holding body 331 to a next layer of the rotor core 311 in the rotation axis direction. At this time, in a case where the thickness in the rotation-axis radial direction of the rotor core 311 is small and is equal to or smaller than 10% of the outermost-diameter portion 602, local stresses are generated at the outermost-diameter portion 602 and the position at which the thickness in the radial direction of the corresponding permanent magnet 321 is small. These local stresses are factors of fatigue breakage during rotation at high speed.

Meanwhile, in this structure of embodiment 1, the recesses 351 as suppression constituents are provided to be disposed, in an inner-diameter portion of the rotor core 311, on the inner side in the rotation-axis radial direction relative to the axial-direction holding bodies 331. Thus, this structure is characterized in that the bending moment generated upon the correction of the innermost-diameter portion 603 of the rotor core 311 in the rotation axis direction is not transmitted to the axial-direction holding body 311, and local stresses are less likely to be generated at the outermost-diameter portion 602 and the position at which the thickness in the rotation-axis radial direction of the permanent magnet 321 is small.

### Embodiment 2

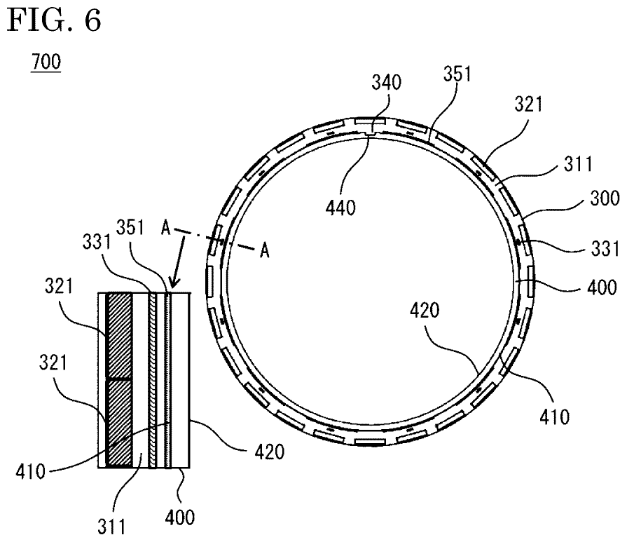

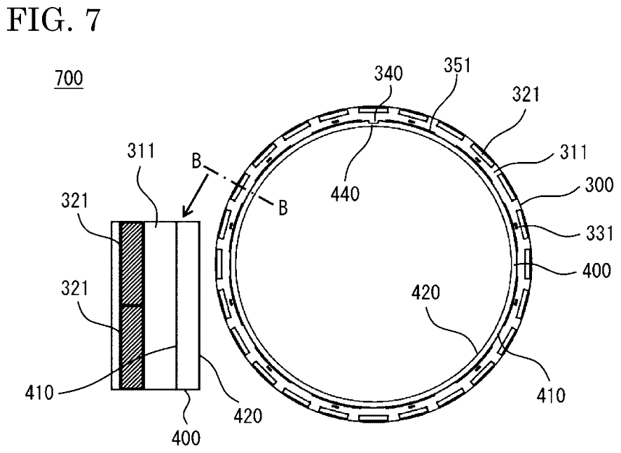

Embodiment 2 of the present disclosure will be described with reference to FIG. 6 and FIG. 7, and the same or corresponding members and portions in the drawings will be described while being denoted by the same reference characters. FIG. 6 is a cross-sectional view showing a rotor in a rotary electric machine according to embodiment 2, the cross-sectional view extending in the rotation-axis circumferential direction of the rotor. FIG. 7 is a cross-sectional view showing the rotor in the rotary electric machine according to embodiment 2, the cross-sectional view extending in the rotation-axis circumferential direction of the rotor.

FIG. 6 and FIG. 7 show a rotor structure 700 obtained by disposing the rotor 300 onto the rotation holding body 400. In the present embodiment 2, each of the permanent magnets 321 has a structure in which the permanent magnet 321 is divided into two pieces in the rotation axis direction, as shown in a cross section taken along the line A-A in FIG. 6 and a cross section taken along the line B-B in FIG. 7.

As the permanent magnet 321, a permanent magnet having a shape obtained by integration without being divided may be used. Alternatively, a bonded magnet directly injection-molded to the rotor core 311 may be used instead of a sintered magnet. Alternatively, a field winding obtained by inserting an armature winding into a core may be used. In the present embodiment 2, the permanent magnet 321 is divided in the rotation axis direction, whereby an optimum division number can be set from a shape before cut-out is performed through whittling in relation to an aspect ratio of the area of a surface in the radial direction. Thus, embodiment 2 is characterized in that: whittling machinability is increased so that machining cost can be decreased; and the orientation of a magnetic domain in the permanent magnet 321 is easily adjusted so that magnetic properties are easily stabilized.

In addition, embodiment 2 is characterized by having a structure in which: each of the recesses 351 arranged on the inner side in the rotation-axis radial direction of the axial-direction holding bodies 331 extends in the rotation axis direction; and the thickness in the rotation-axis radial direction of the recess 351 is equal to or larger than a tightening margin for press-fitting between the rotor core 311 and the rotation holding body 400.

### Embodiment 3

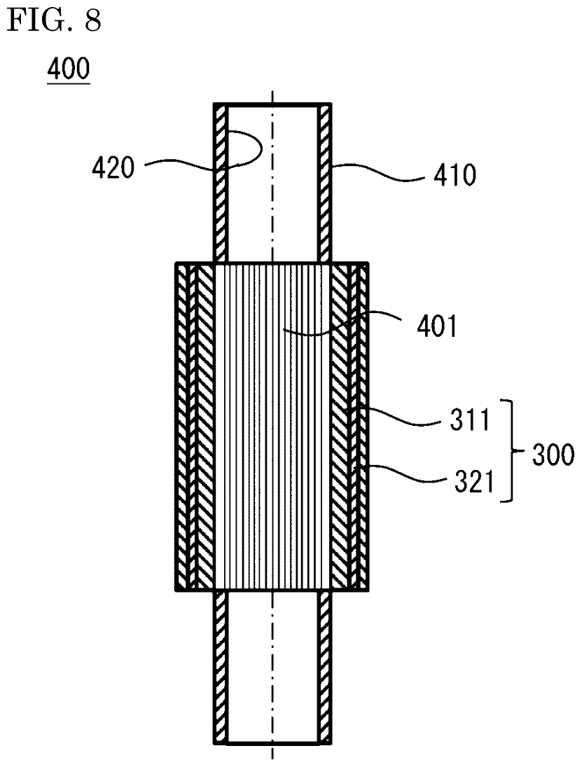

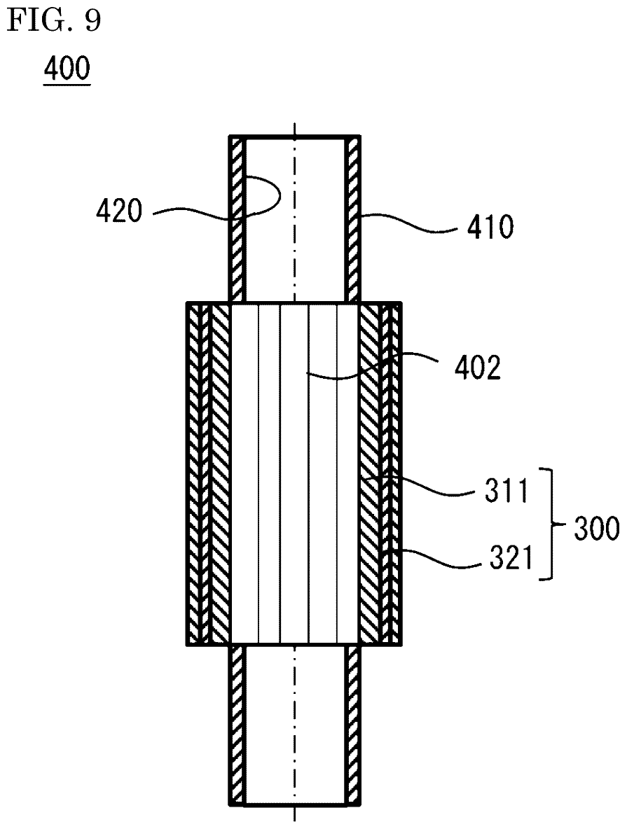

Embodiment 3 of the present disclosure will be described with reference to FIG. 8 and FIG. 9, and the same or corresponding members and portions in the drawings will be described while being denoted by the same reference characters. FIG. 8 is a cross-sectional view showing a modification that is a rotation holding body in a rotary electric machine according to embodiment 3. FIG. 9 is a cross-sectional view showing a modification that is a rotation holding body in the rotary electric machine according to embodiment 3.

FIG. 8 and FIG. 9 each show a structure indicating a modification of the rotation holding body 400 in the above embodiment 1. In the rotation holding body 400 in embodiment 1, the rotor core 311 and the rotation holding body 400 are provided with a tightening margin for press-fitting and are held through press-fitting as shown in FIG. 1.

The structure in each of FIG. 8 and FIG. 9 is obtained by changing the structure of the rotation holding body 400 in embodiment 1. Specifically, in the structure in each of FIG. 8 and FIG. 9, recesses or recess-projection portions such as knurl portions 401 or staking portions 402 as suppression constituents are provided to the outer cylinder portion of the rotation holding body 400. This structure is for a case where, for example, a configuration in which the recesses 351 are not provided on the inner side in the rotation-axis radial direction of the rotor core 311 is employed, or, depending on the accuracies of the inner diameter of the rotor core 311 and the outer diameter of the rotation holding body 400, the state of contact between these parts is not stable at the time of press-fitting, and thus fastening force is desired to be structurally further increased.

In addition, the recesses or the recess-projection portions such as the knurl portions 401 or the staking portions 402 as suppression constituents provided to the outer cylinder portion of the rotation holding body 400 function as a substitute for the suppression constituents which are implemented by the recesses 351 provided on the inner side in the rotation-axis radial direction of the rotor core 311 in the configuration of embodiment 1 and each of which suppresses a bending moment generated with the corresponding axial-direction holding body 331 serving as a fulcrum. That is, the recesses 351 each of which functions as a suppression constituent for suppressing the above bending moment in embodiment 1 and which are provided in the inner-diameter portion of the rotor core 311 may be provided on the rotation holding body 400 side.

Such recesses are provided on the rotation holding body side, and in particular, on the outer cylinder portion of the rotation holding body. In this case as well, the recesses are, in the same manner as the recesses 351 provided in the inner-diameter portion of the rotor core 311, preferably provided at positions that overlap with the positions of the respective axial-direction holding bodies in the circumferential direction. Consequently, each of the recesses can be caused to effectively function as a means for suppressing the above bending moment.

### Embodiment 4

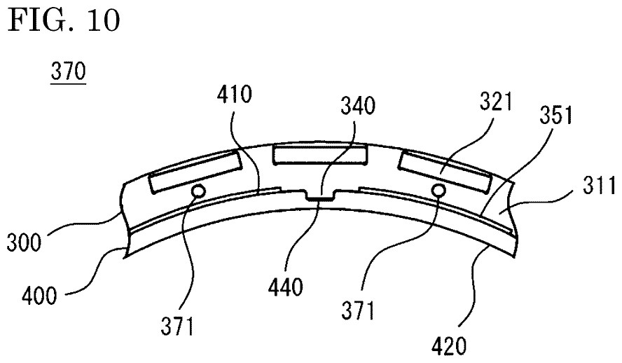

Embodiment 4 of the present disclosure will be described with reference to FIG. 10. FIG. 10 is a cross-sectional view of a main part of a modification that is a rotor in a rotary electric machine according to embodiment 4, the cross-sectional view extending in the rotation-axis circumferential direction of the rotor.

In each of the above embodiments, an example in which a V-swaged structure having a longitudinal direction parallel to the rotation-axis circumferential direction is used has been described as a specific example of each of the axial-direction holding bodies 331. Meanwhile, in the present embodiment 3, a round-swaged core 370 in which round-swaged portions 371 are used as the axial-direction holding bodies 331 may be formed as shown in FIG. 10. Also, a method (not shown) for achieving holding in the axial direction such as pin swaging, screwing, welding, or adhesion may be employed. Also, the axial-direction holding bodies 331 do not have to be arranged at regular intervals in the circumferential direction, the number of the axial-direction holding bodies 331 being half the number of the magnetic poles, and may be arranged at a plurality of positions from the perspective of the strength of the structure and a magnetic circuit configuration.

### Embodiment 5

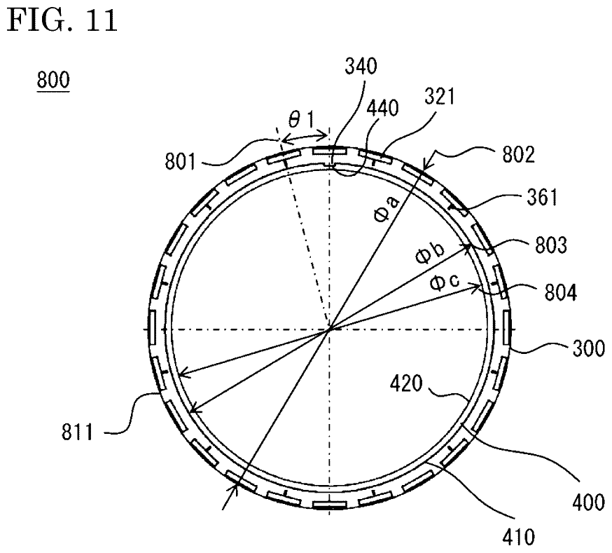

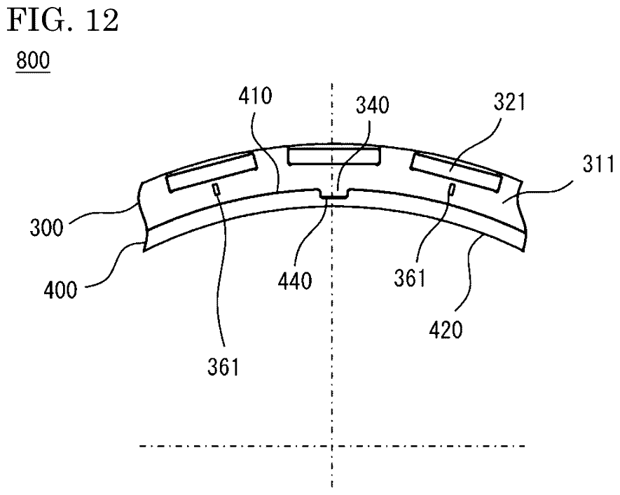

Embodiment 5 of the present disclosure will be described with reference to FIG. 11 and FIG. 12, and the same or corresponding members and portions in the drawings will be described while being denoted by the same reference characters. FIG. 11 is a cross-sectional view showing a rotor in a rotary electric machine according to embodiment 5, the cross-sectional view extending in the rotation-axis circumferential direction of the rotor. FIG. 12 is an enlarged cross-sectional view of a main part, in FIG. 11, of the rotary electric machine according to embodiment 5.

FIG. 11 and FIG. 12 show a rotor structure 800 obtained by disposing the rotor 300 onto the rotation holding body 400. The structure of the rotor according to the present embodiment 5 is composed of: a rotation-axis-radial-direction V-swaged core 811; rotation-axis-radial-direction V-swaged portions 361 as axial-direction holding bodies; the permanent magnets 321; and the rotation holding outer cylinder portion 410 and the rotation holding inner cylinder portion 420 of the rotation holding body 400. As a result, a structure having a comparatively small thickness in the rotation-axis radial direction is employed in the same manner as in the rotor in the above embodiment 1.

In addition, in the present embodiment 5, a configuration in which the rotation-axis-radial-direction V-swaged portions 361 as axial-direction holding bodies are arranged at regular intervals in the circumferential direction on the inner side in the radial direction relative to the permanent magnets 321, the number of the rotation-axis-radial-direction V-swaged portions 361 being half the number of the magnetic poles, is employed as a substitute for a configuration (in the above embodiment 1) including the axial-direction holding bodies 331 and the recesses 351 arranged on the inner side in the rotation-axis radial direction relative to the axial-direction holding bodies 331. This employment leads to obtainment of a structure in which a local stress is less likely to be generated at a position at which the thickness in the rotation-axis radial direction is small.

More specifically, as shown in FIG. 11 and FIG. 12, the rotation-axis-radial-direction V-swaged core 811 is provided, the permanent magnets 321 are arranged at regular intervals in the rotation-axis circumferential direction, the polarities of the permanent magnets 321 are alternately present, the rotation-axis-radial-direction V-swaged portions 361 are arranged at regular intervals in the circumferential direction on the inner side in the radial direction relative to the permanent magnets 321, the number of the rotation-axis-radial-direction V-swaged portions 361 being half the number of the magnetic poles, the core fitting portion 340 for positioning the rotation-axis-radial-direction V-swaged core 811 in the circumferential direction is provided, and each of the rotation-axis-radial-direction V-swaged portions 361 has a V-swaged structure for holding the electromagnetic steel sheets in the rotation axis direction, in which punching has been performed, such that a cross-sectional shape in the rotation-axis circumferential direction becomes a V shape at the time of performing press work on the electromagnetic steel sheets.

Meanwhile, the rotation-axis-radial-direction V-swaged portion 361 easily sustains eddy-current loss owing to residual stress remaining after the punching and decrease in insulation properties between the stacked layers. Considering this, the rotation-axis-radial-direction V-swaged portion 361 is characterized by being disposed on the inner side in the rotation-axis radial direction relative to the corresponding permanent magnet 321 in order to decrease influence of magnetic properties.

In addition, this structure is characterized in that: in a case where an outermost-diameter portion 802 of the rotation-axis-radial-direction V-swaged core 811 is defined as φa and an innermost-diameter portion 803 of the rotation-axis-radial-direction V-swaged core 811 is defined as φb, a relationship is established; and the thickness in the rotation-axis radial direction of the rotation-axis-radial-direction V-swaged core 811 is equal to or smaller than 10% of the outermost-diameter portion 802. The established relationship is as follows.

$$[ Mathematical 4 ]$$

$$\frac{∅ a - ∅ b}{2} \leq 0.1 \cdot ∅ a \qquad ( expression 4 )$$

In addition, this structure is characterized in that: in a case where a diameter 804 of the rotation holding inner cylinder portion 420 of the rotation holding body 400 is defined as φc, a relationship is established; and the thickness in the rotation-axis radial direction of the rotation holding body 400 is equal to or smaller than 10% of the outermost-diameter portion 802 of the rotor core 311. The established relationship is as follows.

$$[ Mathematical 5 ]$$

$$\frac{∅ b - ∅ c}{2} \leq 0.1 \cdot ∅ a \qquad ( expression 5 )$$

In a case where a significant axial deviation occurs when the rotation-axis-radial-direction V-swaged core 811 is fitted to the rotation holding body 400, correction of the innermost-diameter portion 803 of the rotation-axis-radial-direction V-swaged core 811 in the rotation axis direction with respect to the rotation holding body 400 does not lead to generation of a bending moment for which each of the rotation-axis-radial-direction V-swaged portions 361 serves as a fulcrum.

This structure is characterized in that, when each of the rotation-axis-radial-direction V-swaged portions 361 deviates in the rotation-axis radial direction, local stresses are less likely to be generated at the outermost-diameter portion 802 of the rotation-axis-radial-direction V-swaged core 811 and the position at which the thickness in the rotation-axis radial direction of the corresponding permanent magnet 321 is small.

As in this basic configuration of the present embodiment 5, the rotor 300 has a configuration in which the rotation-axis-radial-direction V-swaged portions 361 are, as axial-direction holding bodies and suppression constituents, arranged side-by-side in the circumferential direction on the inner side in the radial direction relative to the permanent magnets 321, the number of the rotation-axis-radial-direction V-swaged portions 361 being half the number of the magnetic poles. This configuration leads to provision of a function of the suppression constituents each of which suppresses application of a bending moment, for which the corresponding rotation-axis-radial-direction V-swaged portion 361 serves as a fulcrum, when the rotation-axis-radial-direction V-swaged core 811 is press-fitted onto the rotation holding body 400, the bending moment being attributed to the employment of the rotor configuration in which the thickness in the radial direction of the rotor core is small.

As a result, it is possible to suppress generation of local stresses at the outermost-diameter portion 802 of the rotation-axis-radial-direction V-swaged core 811 and the position at which the thickness in the rotation-axis radial direction of the corresponding permanent magnet 321 is small. Furthermore, this advantageous effect of the present disclosure becomes more prominent as described above in a case where the proportion of the thickness in the rotation-axis radial direction of the rotation-axis-radial-direction V-swaged core 811 or the rotation holding body 400 to the outer diameter of the outermost-diameter portion 802 is equal to or lower than 10% as described above.

### Embodiment 6

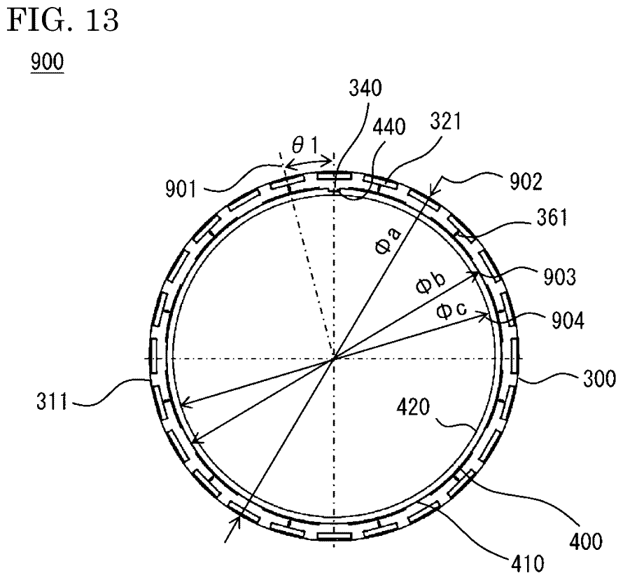

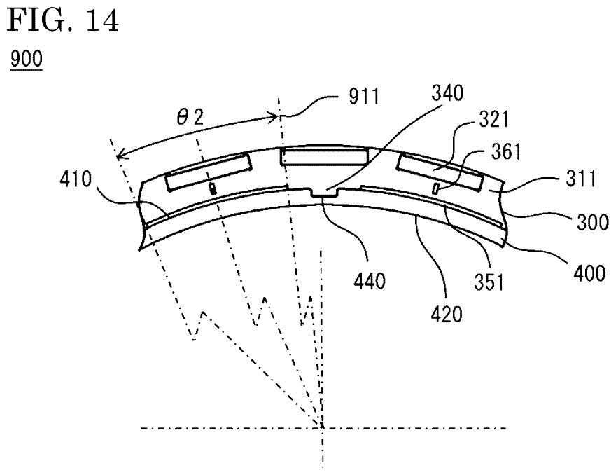

Embodiment 6 of the present disclosure will be described with reference to FIG. 13 and FIG. 14, and the same or corresponding members and portions in the drawings will be described while being denoted by the same reference characters. FIG. 13 is a cross-sectional view showing a rotor in a rotary electric machine according to embodiment 6, the cross-sectional view extending in the rotation-axis circumferential direction of the rotor. FIG. 14 is an enlarged cross-sectional view of a main part, in FIG. 13, of the rotary electric machine according to embodiment 6.

FIG. 13 and FIG. 14 show a rotor structure 900 obtained by disposing the rotor 300 onto the rotation holding body 400. The present embodiment 6 is a modification of the above embodiment 5 and is obtained by partially changing the structure shown in FIG. 4 and FIG. 5 regarding the above embodiment 1 as follows. That is, as shown in FIG. 13 and FIG. 14, for a rotation-axis-radial-direction V-swaged core 911, each of the rotation-axis-radial-direction V-swaged portions 361, as axial-direction holding bodies, having V-swaged structures is rotated by 90 degrees such that the rotation-axis-radial-direction V-swaged portion 361 is oriented with the direction of each long side thereof coinciding with the rotation-axis radial direction.

Meanwhile, the rotation-axis-radial-direction V-swaged portion 361 easily sustains eddy-current loss owing to residual stress remaining after punching and decrease in insulation properties between the stacked layers. Considering this, the rotation-axis-radial-direction V-swaged portion 361 is characterized by being disposed on the inner side in the rotation-axis radial direction relative to the corresponding permanent magnet 321 in order to decrease influence of magnetic properties.

This structure is characterized in that, in a case where an angle 901 between the positions in the rotation-axis circumferential direction of the core fitting portion 340 and each of the axial-direction holding bodies 331 of the rotor core 311 is defined as θ1 and a width angle 911 in the rotation-axis circumferential direction of the corresponding recess 351 as a suppression constituent is defined as θ2, the relationship θ1≤θ2 is established.

In addition, this structure is characterized in that: in a case where an outermost-diameter portion 902 of the rotor core 311 is defined as φa and an innermost-diameter portion 903 of the rotor 311 is defined as φb, a relationship is established; and the thickness in the rotation-axis radial direction of the rotor core 311 is equal to or smaller than 10% of the outermost-diameter portion 902. The established relationship is as follows.

$$[ Mathematical 6 ]$$

$$\frac{∅ a - ∅ b}{2} \leq 0.1 \cdot ∅ a \qquad ( expression 6 )$$

In addition, this structure is characterized in that: in a case where a diameter 904 of the rotation holding inner cylinder portion 420 of the rotation holding body 400 is defined as φc, a relationship is established; and the thickness in the rotation-axis radial direction of the rotation holding body 400 is equal to or smaller than 10% of the outermost-diameter portion 902 of the rotor core 311. The established relationship is as follows.

$$[ Mathematical 7 ]$$

$$\frac{∅ b - ∅ c}{2} \leq 0.1 \cdot ∅ a \qquad ( expression 7 )$$

In a case where a significant axial deviation occurs when the rotor core 311 and the rotation holding body 400 are fitted to each other, correction of the innermost-diameter portion 803 of the rotor core 311 in the rotation axis direction with respect to the rotation holding body 400 does not lead to generation of a bending moment for which each of the rotation-axis-radial-direction V-swaged portions 361 serves as a fulcrum.

This structure is characterized in that, when each of the rotation-axis-radial-direction V-swaged portions 361 deviates in the rotation-axis radial direction, local stresses are less likely to be generated at the outermost-diameter portion 802 of the rotor core 311 and the position at which the thickness in the rotation-axis radial direction of the corresponding permanent magnet 321 is small.

By using the rotation-axis-radial-direction V-swaged portions 361, in a case where a significant axial deviation occurs when the rotor core 311 and the rotation holding body 400 are fitted to each other, correction of the innermost-diameter portion 903 of the rotor core 311 in the rotation axis direction with respect to the rotation holding body 400 does not lead to generation of a bending moment for which each of the rotation-axis-radial-direction V-swaged portions 361 serves as a fulcrum. This structure is characterized in that, when each of the rotation-axis-radial-direction V-swaged portions 361 deviates in the rotation-axis radial direction, local stresses are less likely to be generated at the outermost-diameter portion 902 of the rotor core 3911 and the position at which the thickness in the rotation-axis radial direction of the corresponding permanent magnet 321 is small.

The configuration of the present disclosure is not limited to those in the above embodiments, and a configuration having a function of suppressing generation of a bending moment, for which each of the axial-direction holding bodies serves as a fulcrum, when the rotor core is press-fitted may be employed at a portion of the core near the axial-direction holding body. This employment leads to obtainment of the same advantageous effect. For example, it is also effective to provide openings in portions of the core near the respective axial-direction holding bodies or near the core inner-diameter portion such that each of the openings is located at an appropriate position that enables suppression of the above bending moment. In particular, the openings are preferably located in portions of the core near the core inner-diameter portion, the portions being located at positions that overlap with the respective axial-direction holding bodies in the circumferential direction.

In addition, the following configuration example has been shown in each of the embodiments. That is, a structure in which one magnet having the shape of a flat plate is disposed in a cross-sectional view as each of the permanent magnets 321 forming the magnetic poles of the rotor has been employed. Alternatively, in the case of application to a structure in which the thickness in the radial direction of the rotor core is small, arrangement may be made such that a pair of magnets having the shapes of flat plates are arrayed in a linear pattern parallel to the circumferential direction so as to form each magnetic pole. Alternatively, a configuration may be employed in which the pair of magnets having the shapes of flat plates are arrayed in a V pattern so as to be tilted relative to the circumferential direction. In each case, the basic advantageous effect of the present disclosure described in each of the embodiments can be obtained in the same manner.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the specification of the present disclosure. For example, at least one of the constituent components may be modified, added, or eliminated. At least one of the constituent components mentioned in at least one of the preferred embodiments may be selected and combined with the constituent components mentioned in another preferred embodiment.

### INDUSTRIAL APPLICABILITY

The present disclosure is suitable for realizing a rotary electric machine capable of suppressing concentration of stress on a thin portion of a rotor core.

### DESCRIPTION OF THE REFERENCE CHARACTERS

100 rotary electric machine
210 housing
211 frame
212 end plate
220 armature
221 coil
222 wire connection plate
223 armature core
224 bobbin
300 rotor
311 rotor core
321 permanent magnet
331 axial-direction holding body
340 core fitting portion
351 recess
361 rotation-axis-radial-direction V-swaged portion
370 round-swaged core
371 round-swaged portion
400 rotation holding body
401 knurl portion
402 staking portion
410 rotation holding outer cylinder portion
420 rotation holding inner cylinder portion
440 rotation holding fitting portion
500 bearing

1-9. (canceled)

10. A rotary electric machine comprising:
a stator; and
a rotor composed of
a rotor core disposed with a magnetic gap between the rotor core and the stator and formed of electromagnetic steel sheets arranged to be stacked, and
a plurality of permanent magnets arranged in the rotor core at regular intervals in a circumferential direction, wherein
axial-direction holding bodies, a rotation holding body, and suppression constituents are provided,
the axial-direction holding bodies are arranged on an inner side in a radial direction relative to the permanent magnets, the number of the axial-direction holding bodies being half the number of magnetic poles of the rotor,
the rotation holding body is formed in a cylindrical shape and has an outer cylinder portion on which the rotor core is disposed, and
each of the suppression constituents suppresses a bending moment for which the corresponding axial-direction holding body serves as a fulcrum.

11. The rotary electric machine according to claim 10, wherein the axial-direction holding bodies are arranged at regular intervals, the number of the axial-direction holding bodies being half the number of the magnetic poles of the rotor.

12. The rotary electric machine according to claim 10, wherein each of the suppression constituents is implemented by a recess formed in an inner circumferential portion of the rotor core so as to be located at a position of the corresponding axial-direction holding body.

13. The rotary electric machine according to claim 10, wherein each of the suppression constituents is implemented by a recess formed in the outer cylinder portion of the rotation holding body.

14. The rotary electric machine according to claim 10, wherein each of the axial-direction holding bodies has a shape of a V-swaged portion.

15. The rotary electric machine according to claim 10, wherein each of the axial-direction holding bodies has a shape of a round-swaged portion.

16. The rotary electric machine according to claim 10, wherein a thickness in the radial direction of the rotor core is equal to or smaller than 10% of an outermost circumferential diameter of the rotor core.

17. The rotary electric machine according to claim 11, wherein a thickness in the radial direction of the rotor core is equal to or smaller than 10% of an outermost circumferential diameter of the rotor core.

18. The rotary electric machine according to claim 12, wherein a thickness in the radial direction of the rotor core is equal to or smaller than 10% of an outermost circumferential diameter of the rotor core.

19. The rotary electric machine according to claim 13, wherein a thickness in the radial direction of the rotor core is equal to or smaller than 10% of an outermost circumferential diameter of the rotor core.

20. The rotary electric machine according to claim 14, wherein a thickness in the radial direction of the rotor core is equal to or smaller than 10% of an outermost circumferential diameter of the rotor core.

21. The rotary electric machine according to claim 15, wherein a thickness in the radial direction of the rotor core is equal to or smaller than 10% of an outermost circumferential diameter of the rotor core.

22. The rotary electric machine according to claim 10, wherein a thickness in the radial direction from the outer cylinder portion of the rotation holding body to the rotor core is equal to or smaller than 10% of an outermost circumferential diameter of the rotor core.

23. The rotary electric machine according to claim 11, wherein a thickness in the radial direction from the outer cylinder portion of the rotation holding body to the rotor core is equal to or smaller than 10% of an outermost circumferential diameter of the rotor core.

24. The rotary electric machine according to claim 12, wherein a thickness in the radial direction from the outer cylinder portion of the rotation holding body to the rotor core is equal to or smaller than 10% of an outermost circumferential diameter of the rotor core.

25. The rotary electric machine according to claim 13, wherein a thickness in the radial direction from the outer cylinder portion of the rotation holding body to the rotor core is equal to or smaller than 10% of an outermost circumferential diameter of the rotor core.

26. The rotary electric machine according to claim 14, wherein a thickness in the radial direction from the outer cylinder portion of the rotation holding body to the rotor core is equal to or smaller than 10% of an outermost circumferential diameter of the rotor core.

27. The rotary electric machine according to claim 15, wherein a thickness in the radial direction from the outer cylinder portion of the rotation holding body to the rotor core is equal to or smaller than 10% of an outermost circumferential diameter of the rotor core.

28. The rotary electric machine according to claim 12, wherein the recess has such a shape that an angle thereof in the circumferential direction is equal to or larger than a value expressed as 360°/(number of poles).

29. The rotary electric machine according to claim 13, wherein the recess has such a shape that an angle thereof in the circumferential direction is equal to or larger than a value expressed as 360°/(number of poles).
